(19) United States
(12) Patent Application Publication
(10) Pub. No.: US 2025/0056602 A1
(43) Pub. Date: Feb. 13, 2025

(54) CHANNEL OCCUPANCY TIME TRANSMISSIONS WITH A SIDELINK-SYNCHRONIZATION SIGNAL BLOCK GAP SLOT

(71) Applicant: QUALCOMM Incorporated, San Diego, CA (US)

(72) Inventors: Chih-Hao LIU, San Diego, CA (US); Jae Ho RYU, San Diego, CA (US); Xiaoxia ZHANG, San Diego, CA (US); Giovanni CHISCI, San Diego, CA (US); Jing SUN, San Diego, CA (US); Qing LI, Princeton Junction, NJ (US)

(21) Appl. No.: 18/745,123

(22) Filed: Jun. 17, 2024

Related U.S. Application Data
(60) Provisional application No. 63/519,073, filed on Aug. 11, 2023.

(51) Int. Cl. H04W 74/0808; H04W 92/18

(52) U.S. Cl. CPC H04W 74/0808; H04W 92/18

(57) ABSTRACT

Methods, systems, and devices for wireless communication are described. A non-sidelink synchronization signal (SLSS)-transmitting user equipment (UE) may initiate a channel occupancy time (COT) including multiple contiguous slots and a gap slot. The non-SLSS UE may detect an SLSS UE (capable of transmitting sidelink synchronization signal blocks (S-SSBs)) and assume that the gap slot will be filled with an S-SSB. The non-SLSS may transmit a sidelink message during the COT after the gap slot, based on the assumption. Alternatively, based on the SLSS UE indicating that it is capable of transmitting the S-SSB, the non-SLSS UE may schedule transmission of the S-SSB such that the gap slot is filled. If the SLSS UE is incapable of transmitting the S-SSB, the non-SLSS UE may determine a method for transmitting the sidelink message during the already-initiated COT or during another COT.

### CROSS REFERENCE

The present application for patent claims the benefit of U.S. Provisional Patent Application No. 63/519,073 by LIU et al., entitled “CHANNEL OCCUPANCY TIME TRANSMISSIONS WITH A SIDELINK-SYNCHRONIZATION SIGNALBLOCK GAP SLOT,” filed Aug. 11, 2023, assigned to the assignee hereof, and expressly incorporated by reference herein.

### FIELD OF TECHNOLOGY

The present disclosure relates to wireless communication, including channel occupancy time (COT) transmissions with a sidelink-synchronization signal block (S-SSB) gap slot.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel occupancy time transmissions with a sidelink-synchronization signal block gap slot. For example, the described techniques provide for maintenance of a channel occupancy time (COT) without explicit signaling and sharing of the COT with a sidelink synchronization signal (SLSS) UE. For example, a non-SLSS UE may initiate a COT and identify that the COT includes one or more gap slots (e.g., slots allocated for transmission of a sidelink synchronization signal block (S-SSB) message). In order to maintain the COT, the non-SLSS UE may signal an SLSS UE to transmit SSB during the gap slot. This additional signaling between the non-SLSS UE and the SLSS UE may be avoided, however. If the non-SLSS UE detects that the SLSS UE is present, the non-SLSS UE may assume that the SLSS UE may transmit an S-SSB during the gap slot and maintain the COT. That is, the non-SLSS UE may refrain from explicitly sharing the COT with the SLSS UE and requesting the SLSS UE to transmit the S-SSB during the gap slot, and instead, the non-SLSS UE may assume that the SLSS UE will transmit the S-SSB. In this way, the non-SLSS UE may continue to transmit its sidelink message during the COT and after the gap slot, as the COT is assumed to be maintained through the transmission by the SLSS UE.

Alternatively, the non-SLSS UE may receive an indication of a capability of the SLSS UE to transmit an S-SSB during the gap slot. If the SLSS UE has this capability, the non-SLSS UE may transmit a message to the SLSS UE requesting that the SLSS UE transmit the S-SSB during the gap slot to maintain the COT. If the SLSS UE lacks the capability to transmit the S-SSB, the non-SLSS UE may perform another action or procedure to facilitate transmission of a sidelink message. For example, the non-SLSS UE may shift the timing of the sidelink message transmission to avoid the gap slot, or the non-SLSS UE may perform an listen-before-talk (LBT) operation to reinitiate or continue the COT after the gap slot and transmit the sidelink message after the gap slot. In this way, the explicit signaling to share the COT is only used if the SLSS UE is capable of transmitting the S-SSB during the gap slot; and explicit request is not transmitted by the non-SLSS UE if the SLSS UE is not capable of the S-SSB transmission.

A method for wireless communication by a first UE is described. The method may include initiating a COT for transmission of one or more sidelink messages by the first UE, where the COT includes multiple contiguous slots, determining that the multiple contiguous slots include a gap slot that is allocated for a S-SSB transmission, where the gap slot is unavailable for the transmission of the one or more sidelink messages by the first UE, detecting a second UE that is capable of transmitting S-SSB transmissions, and transmitting at least a portion of the one or more sidelink messages during the COT and after the gap slot, the transmission after the gap slot based on detection of the second UE.

A first UE for wireless communication is described. The first UE may include one or more memories storing processor executable code, and one or more processors coupled with the one or more memories. The one or more processors may individually or collectively operable to execute the code to cause the first UE to initiate a COT for transmission of one or more sidelink messages by the first UE, where the COT includes multiple contiguous slots, determine that the multiple contiguous slots include a gap slot that is allocated for a S-SSB transmission, where the gap slot is unavailable for the transmission of the one or more sidelink messages by the first UE, detect a second UE that is capable of transmitting S-SSB transmissions, and transmit at least a portion of the one or more sidelink messages during the COT and after the gap slot, the transmission after the gap slot based on detection of the second UE.

Another first UE for wireless communication is described. The first UE may include means for initiating a COT for transmission of one or more sidelink messages by the first UE, where the COT includes multiple contiguous slots, means for determining that the multiple contiguous slots include a gap slot that is allocated for a S-SSB transmission, where the gap slot is unavailable for the transmission of the one or more sidelink messages by the first UE, means for detecting a second UE that is capable of transmitting S-SSB transmissions, and means for transmitting at least a portion of the one or more sidelink messages during the COT and after the gap slot, the transmission after the gap slot based on detection of the second UE.

A non-transitory computer-readable medium storing code for wireless communication is described. The code may include instructions executable by a processor to initiate a COT for transmission of one or more sidelink messages by the first UE, where the COT includes multiple contiguous slots, determine that the multiple contiguous slots include a gap slot that is allocated for a S-SSB transmission, where the gap slot is unavailable for the transmission of the one or more sidelink messages by the first UE, detect a second UE that is capable of transmitting S-SSB transmissions, and transmit at least a portion of the one or more sidelink messages during the COT and after the gap slot, the transmission after the gap slot based on detection of the second UE.

Some examples of the method, first UEs, and non-transitory computer-readable medium described herein may further include operations, features, means, or instructions for assuming that a S-SSB may be transmitted in the gap slot based on the detection of the second UE.

In some examples of the method, first UEs, and non-transitory computer-readable medium described herein, the gap slot may be configured for transmission by the second UE of the S-SSB transmission.

Some examples of the method, first UEs, and non-transitory computer-readable medium described herein may further include operations, features, means, or instructions for refraining from performing a LBT procedure during the COT after the gap slot based on the detection of the second UE.

In some examples of the method, first UEs, and non-transitory computer-readable medium described herein, the first UE lacks a capability to transmit sidelink synchronization signals and the second UE may be capable of transmitting sidelink synchronization signals.

A method for wireless communication by a first UE is described. The method may include initiating a COT for transmission of one or more sidelink messages by the first UE, where the COT includes multiple contiguous slots, determining that the multiple contiguous slots include a gap slot that is allocated for a S-SSB transmission, where the gap slot is unavailable for the transmission of the one or more sidelink messages by the first UE, performing a procedure to facilitate the transmission of the one or more sidelink messages during the COT, and transmitting at least a portion of the one or more sidelink messages during the COT and after performance of the procedure.

A first UE for wireless communication is described. The first UE may include one or more memories storing processor executable code, and one or more processors coupled with the one or more memories. The one or more processors may individually or collectively operable to execute the code to cause the first UE to initiate a COT for transmission of one or more sidelink messages by the first UE, where the COT includes multiple contiguous slots, determine that the multiple contiguous slots include a gap slot that is allocated for a S-SSB transmission, where the gap slot is unavailable for the transmission of the one or more sidelink messages by the first UE, perform a procedure to facilitate the transmission of the one or more sidelink messages during the COT, and transmit at least a portion of the one or more sidelink messages during the COT and after performance of the procedure.

Another first UE for wireless communication is described. The first UE may include means for initiating a COT for transmission of one or more sidelink messages by the first UE, where the COT includes multiple contiguous slots, means for determining that the multiple contiguous slots include a gap slot that is allocated for a S-SSB transmission, where the gap slot is unavailable for the transmission of the one or more sidelink messages by the first UE, means for performing a procedure to facilitate the transmission of the one or more sidelink messages during the COT, and means for transmitting at least a portion of the one or more sidelink messages during the COT and after performance of the procedure.

A non-transitory computer-readable medium storing code for wireless communication is described. The code may include instructions executable by a processor to initiate a COT for transmission of one or more sidelink messages by the first UE, where the COT includes multiple contiguous slots, determine that the multiple contiguous slots include a gap slot that is allocated for a S-SSB transmission, where the gap slot is unavailable for the transmission of the one or more sidelink messages by the first UE, perform a procedure to facilitate the transmission of the one or more sidelink messages during the COT, and transmit at least a portion of the one or more sidelink messages during the COT and after performance of the procedure.

Some examples of the method, first UEs, and non-transitory computer-readable medium described herein may further include operations, features, means, or instructions for receiving a signal indicative of a capability of a second UE to transmit sidelink synchronization signal block transmissions during the gap slot, where the procedure to facilitate the transmission of the one or more sidelink messages during the COT is performed based on the capability.

In some examples of the method, first UEs, and non-transitory computer-readable medium described herein, performing the procedure may include operations, features, means, or instructions for terminating the COT based on the signal indicating that the second UE lacks a capability to transmit the S-SSB transmissions during the gap slot, where one or more remaining slots of the multiple contiguous slots may be excluded from the COT and performing a LBT procedure to reinitiate the COT after the gap slot based on the termination, where the LBT procedure may be of a first type based on the one or more remaining slots being excluded from the COT.

Some examples of the method, first UEs, and non-transitory computer-readable medium described herein may further include operations, features, means, or instructions for terminating the COT based on the signal indicating that the second UE lacks a capability to transmit the S-SSB transmissions during the gap slot, where one or more remaining slots of the multiple contiguous slots may be within the COT and performing a LBT procedure to reinitiate the COT after the gap slot based on the termination, where the LBT procedure may be of a second type based on the one or more remaining slots being within the COT.

In some examples of the method, first UEs, and non-transitory computer-readable medium described herein, receiving the signal may include operations, features, means, or instructions for establishing a RRC connection with the second UE and receiving a RRC message indicative of a capability of the second UE to transmit the S-SSB transmissions during the gap slot.

In some examples of the method, first UEs, and non-transitory computer-readable medium described herein, receiving the signal may include operations, features, means, or instructions for receiving a S-SSB indicative of a capability of the second UE to transmit the S-SSB transmissions during the gap slot, where the capability may be quantized with one or more code points included in the S-SSB.

In some examples of the method, first UEs, and non-transitory computer-readable medium described herein, the S-SSB may be indicative of a capability of the second UE to transmit the S-SSB transmissions during all of a set of candidate slots that include the gap slot or during a subset of the set of candidate slots and the subset includes the gap slot.

In some examples of the method, first UEs, and non-transitory computer-readable medium described herein, performing the procedure may include operations, features, means, or instructions for adjusting a starting position of the multiple contiguous slots to avoid the gap slot based on the signal indicating that the second UE lacks a capability to transmit the S-SSB transmissions during the gap slot.

A method for wireless communication by a first UE is described. The method may include transmitting a signal indicative of a capability of the first UE to transmit S-SSB transmissions during a portion or all of a set of multiple S-SSB candidate slots and transmitting one or more S-SSB transmissions during the set of multiple S-SSB candidate slots in accordance with the capability.

A first UE for wireless communication is described. The first UE may include one or more memories storing processor executable code, and one or more processors coupled with the one or more memories. The one or more processors may individually or collectively operable to execute the code to cause the first UE to transmit a signal indicative of a capability of the first UE to transmit S-SSB transmissions during a portion or all of a set of multiple S-SSB candidate slots and transmit one or more S-SSB transmissions during the set of multiple S-SSB candidate slots in accordance with the capability.

Another first UE for wireless communication is described. The first UE may include means for transmitting a signal indicative of a capability of the first UE to transmit S-SSB transmissions during a portion or all of a set of multiple S-SSB candidate slots and means for transmitting one or more S-SSB transmissions during the set of multiple S-SSB candidate slots in accordance with the capability.

A non-transitory computer-readable medium storing code for wireless communication is described. The code may include instructions executable by a processor to transmit a signal indicative of a capability of the first UE to transmit S-SSB transmissions during a portion or all of a set of multiple S-SSB candidate slots and transmit one or more S-SSB transmissions during the set of multiple S-SSB candidate slots in accordance with the capability.

Some examples of the method, first UEs, and non-transitory computer-readable medium described herein may further include operations, features, means, or instructions for receiving a message that schedules the first UE to transmit a S-SSB transmission during one of the S-SSB candidate slots in accordance with the capability and transmitting the S-SSB transmission during the portion or all of the set of multiple S-SSB candidate slots based on the message.

In some examples of the method, first UEs, and non-transitory computer-readable medium described herein, transmitting the signal may include operations, features, means, or instructions for establishing a RRC connection with a second UE and transmitting a RRC message indicative of the capability of the first UE to transmit the S-SSB transmission during the portion or all of the set of multiple S-SSB candidate slots.

In some examples of the method, first UEs, and non-transitory computer-readable medium described herein, transmitting the signal may include operations, features, means, or instructions for transmitting a S-SSB indicative of the capability of the first UE to transmit the S-SSB transmission during the portion or all of the set of multiple S-SSB candidate slots, where the capability may be quantized with one or more code points included in the S-SSB transmission.

### BRIEF DESCRIPTION OF THE DRAWINGS

FIG. 1 shows an example of a wireless communications system that supports channel occupancy time transmissions (COT) with a sidelink-synchronization signal block (S-SSB) gap slot in accordance with one or more aspects of the present disclosure.

FIG. 2 shows an example of a wireless communications system that supports COT transmissions with a S-SSB gap slot in accordance with one or more aspects of the present disclosure.

FIGS. 3 and 4 show examples of process flows that support COT transmissions with a S-SSB gap slot in accordance with one or more aspects of the present disclosure.

FIGS. 5 and 6 show block diagrams of devices that support COT transmissions with a S-SSB gap slot in accordance with one or more aspects of the present disclosure.

FIG. 7 shows a block diagram of a communications manager that supports COT transmissions with a S-SSB gap slot in accordance with one or more aspects of the present disclosure.

FIG. 8 shows a diagram of a system including a device that supports COT transmissions with a S-SSB gap slot in accordance with one or more aspects of the present disclosure.

FIGS. 9 through 15 show flowcharts illustrating methods that support COT transmissions with a S-SSB gap slot in accordance with one or more aspects of the present disclosure.

### DETAILED DESCRIPTION

In an unlicensed wireless communications system (e.g., an unlicensed New Radio (NR)) system), user equipment (UE) may communicate via sidelink. For example, a UE may be capable of broadcasting sidelink synchronization signal block (S-SSB) transmissions, and thus may be referred to as a sidelink synchronization signal (SLSS)-capable UE. The UE may transmit S-SSBs during particular candidate slots, including S-SSB slots or other S-SSB instances. A first UE (e.g., a non-SLSS UE) may determine when to communicate data based on a channel occupancy time (COT), which may indicate a structure of multiple resources (e.g., slots), each slot including designated resources for downlink, uplink sidelink, or flexible communications, among other uses. The first UE may perform a listen-before-talk (LBT) operation to establish that a channel is available for transmission of a sidelink message. Based on determining that the channel is available, the first UE may initiate a COT during which the first UE may transmit the sidelink message. However, if an S-SSB slot may interrupt the COT (which is referred to herein as a gap slot due to the S-SSB slot creating a gap in the COT when S-SSB slots are excluded from a resource pool for data transmissions). In such cases, the first UE may be unable to transmit the sidelink message during or after the gap slot, even if the COT duration extends beyond the gap slot. As such, the first UE may risk losing the COT and interrupting communications.

The first UE may share the COT with a second UE (e.g., an SLSS UE), which may then transmit an S-SSB during the gap slot and maintain the COT such that the first UE may continue to transmit after the gap slot. However, this procedure may require the first UE to transmit a message to the second UE to share the COT, which may increase signaling overhead. Additionally, the second UE may lack a capability to transmit the S-SSB during the particular gap slot (e.g., if there is not enough time to process the message before the gap slot).

To maintain the COT without explicitly signaling and sharing the COT with the second, SLSS UE, the first, non-SLSS UE may initiate a COT and identify that the COT includes one or more gap slots (e.g., S-SSB slots) during which the first UE is unable to transmit an S-SSB to pad the gap and maintain the COT. If the first UE detects that the second UE is present, however, the first UE may assume that the second UE may send an S-SSB during the gap slot and maintain the COT as if it has been shared. That is, because the second UE is capable of transmitting S-SSBs, the first UE may refrain from sharing the COT with the second UE and requesting the second UE to transmit the S-SSB during the gap slot. Instead, the first UE may assume that the second UE will transmit the S-SSB. In this way, the first UE may transmit a sidelink message based on detecting the second UE and the assumption that the gap is filled.

Alternatively, the first UE may receive an indication of a capability of the second UE to transmit an S-SSB during the gap slot. If the second UE has this capability, the first UE may transmit a message to the second UE requesting that the second UE transmit the S-SSB during the gap slot to maintain the COT. If the second UE lacks the capability to transmit the S-SSB, the first UE may perform another action or procedure to facilitate transmission of a sidelink message. For example, the first UE may shift the timing of the sidelink message transmission to avoid the gap slot, or the first UE may perform an LBT operation to reinitiate or continue the COT after the gap slot and transmit the sidelink message after the gap slot.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to channel occupancy time transmissions with a sidelink-synchronization signal block gap slot.

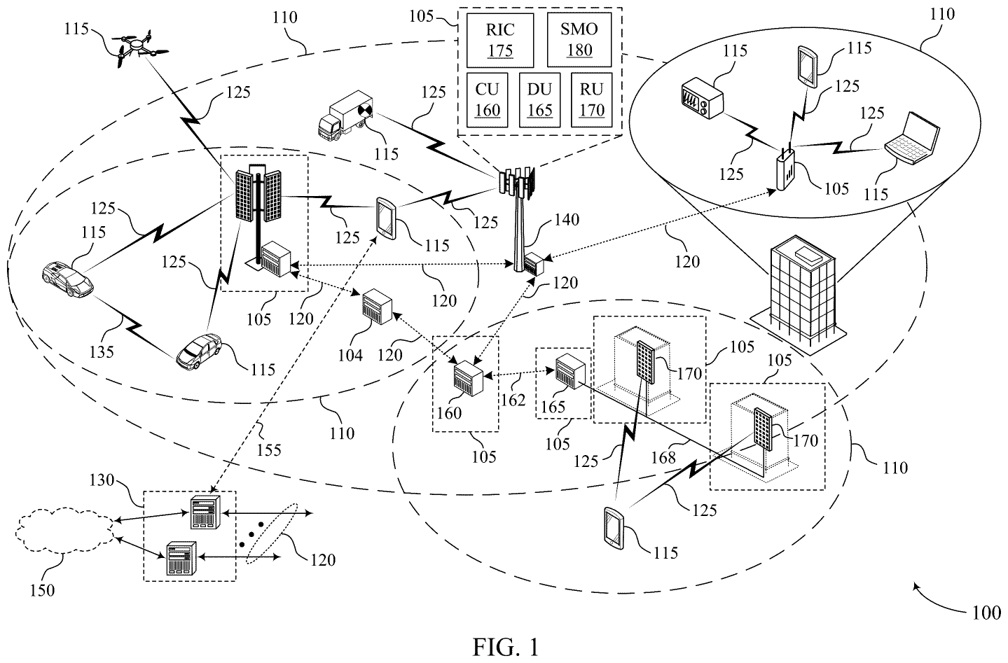

FIG. 1 shows an example of a wireless communications system 100 that supports COT transmissions with a sidelink-synchronization signal block gap slot in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support COT transmissions with a sidelink-synchronization signal block gap slot as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support sidelink communications between multiple UEs 115. For example, UEs 115 in an unlicensed NR system may transmit S-SSBs during S-SSB slots. To address LBT uncertainties for S-SSB transmissions, the wireless communications system 100 may support additional S-SSB opportunities (e.g., instances) following each nominal S-SSB instance (e.g., slots). The UE 115 may attempt to transmit via additional candidate S-SSB occasions regardless of whether or not the UE 115 transmitted via the nominal S-SSB occasions. Each nominal S-SSB slot may correspond to K additional candidate S-SSB occasion(s) in different time slots(s), and a gap between each of the candidate S-SSB occasions may be pre-configured.

In some examples, a data resource pool may exclude S-SSB slots, thus creating the gaps in the COT and reducing the ability for UEs 115 to communicate sidelink messages efficiently. For example, if a data transmission is across S-SSB occasions in the COT and a transmitting UE 115 is unable to transmit an S-SSB during the gap slot to fill the gap, the UE 115 may prematurely terminate the COT at the gap slot. A UE 115 incapable of transmitting synchronization signals (e.g., a non-SLSS UE, a COT initiator) may initiate a COT and identify that there is a gap slot in the COT created by an S-SSB slot. If the COT initiator has detected SLSS UEs 115 (e.g., also referred to herein as synchronization reference (syncRef) UEs 115 or nodes) capable of transmitting S-SSBs, the non-SLSS UE 115 may request the SLSS UE 115 to transmit an S-SSB to pad the gap slot. This may be practically beneficial if the COT initiator (e.g., the non-SLSS UE) is not an SLSS or syncRef UE 115. However, the SLSS UE 115 may be incapable of transmitting the S-SSB (e.g., even if the S-SSB slot is included in the COT, there is no guarantee that the SLSS UE 115 may transmit the S-SSB even if an LBT passes).

In some cases, the non-SLSS UE 115 may detect an SLSS UE 115 and share the COT with the SLSS UE 115. Then, the non-SLSS UE 115 may schedule an S-SSB transmission in the gap slot by the SLSS UE 115, and the non-SLSS UE 115 may resume the COT transmission (e.g., a sidelink message transmission) after the gap slot after the SLSS UE 115 transmits the S-SSB and pads the gap. However, there is no guarantee that the SLSS UE 115 will transmit the S-SSB in the gap slot (e.g., an S-SSB candidate slot). For example, if the non-SLSS UE 115 shares the COT and requests transmission of the S-SSB just before the gap slot, the SLSS UE 115 may lack sufficient time to actually transmit the S-SSB. In addition, scheduling the SLSS UE 115 to transmit the S-SSB to pad the gap slot may increase complexity and power consumption of the SLSS UE 115, as well as increase signaling overhead.

To reduce the complexity, power consumption, and signaling overhead, the wireless communications system 200 may support maintenance of the COT without explicit signaling and sharing of the COT with the SLSS UE 115. For example, the first, non-SLSS UE 115 may initiate a COT and identify that the COT includes one or more gap slots (e.g., S-SSB slots). If the first UE 115 detects that the second UE 115 is present, however, the first UE 115 may assume that the second UE 115 may transmit an S-SSB during the gap slot and maintain the COT. That is, the first UE 115 may refrain from sharing the COT with the second UE 115 and requesting the second UE 115 to transmit the S-SSB during the gap slot. Instead, the first UE 115 may assume that the second UE 115 will transmit the S-SSB. In this way, the first UE 115 may transmit a sidelink message based on detecting the second UE 115 and the assumption that the gap is filled (thus maintaining the COT).

Alternatively, the first UE 115 may receive an indication of a capability of the second UE 115 to transmit an S-SSB during the gap slot. If the second UE 115 has this capability, the first UE may transmit a message to the second UE 115 requesting that the second UE 115 transmit the S-SSB during the gap slot to maintain the COT. If the second UE 115 lacks the capability to transmit the S-SSB, the first UE 115 may perform another action or procedure to facilitate transmission of a sidelink message. For example, the first UE 115 may shift the timing of the sidelink message transmission to avoid the gap slot, or the first UE 115 may perform an LBT operation to reinitiate or continue the COT after the gap slot and transmit the sidelink message after the gap slot.

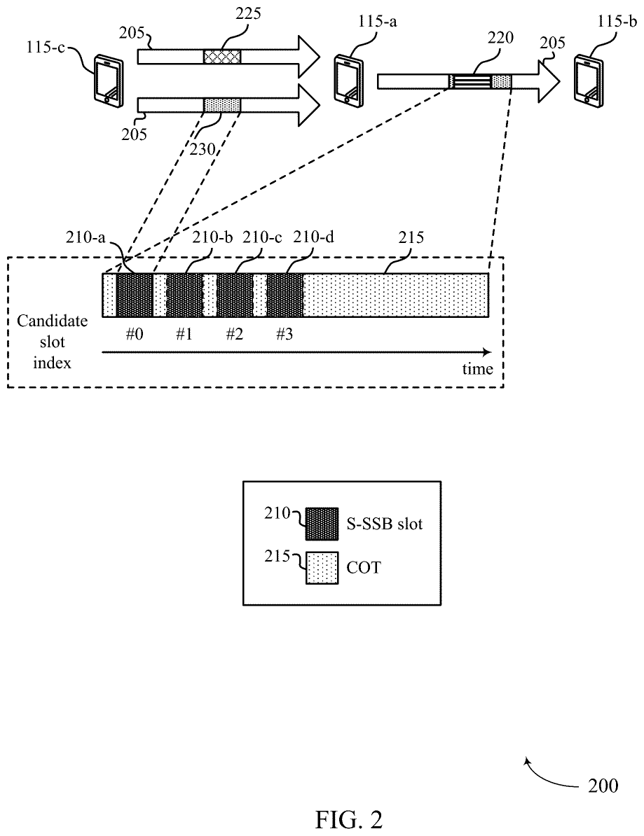

FIG. 2 shows an example of a wireless communications system 200 that supports COT transmissions with a sidelink-synchronization signal block gap slot in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, and a UE 115-c which may be examples of UEs 115 described herein. The UE 115-a may be an example of a non-SLSS UE (e.g., a UE that does not transmit SLSSs, such as S-SSBs 230), the UE 115-c may be an example of an SLSS UE (e.g., a UE capable of transmitting SLSSs, such as S-SSBs 230), and may also be referred to as a synchronization reference (syncRef) UE, and the UE 115-b may be an example of a non-SLSS UE or an SLSS UE.

The UEs 115 may communicate via communication links 205, which may be examples of sidelinks (e.g., communication links 125 as descried herein with reference to FIG. 1). For example, the UE 115-a may establish sidelink communications with the UE 115-b via a communication link 205. In some cases, one or more of the UEs 115 may also communicate with a network entity 105, a network node, or another network device.

To begin sidelink communication with the UE 115-b, the UE 115-a may initiate a COT 215 for transmission of one or more sidelink messages 220 to the UE 115-b. The COT 215 may include multiple contiguous slots, and as such the UE 115-a may perform a multiple contiguous slot transmission (MCSt) to the UE 115-b. The multiple contiguous slots of the COT 215 may include a gap slot that is allocated (e.g., configured for) for an S-SSB transmission, where the gap slot is unavailable for the transmission of the sidelink messages 220. The gap slot may be an example of an S-SSB slot 210, which may be excluded from a data resource pool (which creates the gap in the MCSt). For example, the COT 215 may include at least an S-SSB slot 210-a (e.g., corresponding to a candidate slot index #0), an S-SSB slot 210-b (e.g., corresponding to a candidate slot index #1), an S-SSB slot 210-c (e.g., corresponding to a candidate slot index #2), an S-SSB slot 210-d (e.g., corresponding to a candidate slot index #3), or any combination thereof.

In some examples, to ensure maintenance of the COT 215, the UE 115-a (e.g., the non-SLSS UE which is to perform a sidelink MCSt) may detect the UE 115-c, which is capable of transmitting S-SSBs 230. Based on detecting the UE 115-c, the UE 115-a may assume that the UE 115-c will transmit an S-SSB 230 in a gap slot (any of the S-SSB slots 210) in the middle of the MCSt. Thus, the UE 115-a may assume that the gap slot will be padded. In this way, the UE 115-a may behave as if it scheduled the UE 115-c to transmit the S-SSB in the S-SSB slots 210 (e.g., any active candidate S-SSB slots) within the COT 215.

Because of the assumption that the gap slot is filled, the UE 115-a may refrain from performing an additional LBT operation during the COT 215 and before resuming the MCSt after the S-SSB slot 210. Then, the UE 115-a may transmit, to the UE 115-b, at least a portion of one or more sidelink messages 220 during the COT 215 and after the S-SSB slot 210 based on the detection of the UE 115-b. Such techniques may result in the UE 115-a refraining from transmitting a triggering or scheduling signal to the UE 115-c indicating to transmit the S-SSB 230 to pad the S-SSB slot 210, which may reduce signaling overhead, complexity, and power consumption for the UEs 115.

Alternatively, the UE 115-c may support different classes of capabilities. Some SLSS UEs 115 may support transmission of S-SSBs 230 in a subset of S-SSB slots 210 (e.g., S-SSB candidate slots). For example, such UEs 115 may transmit S-SSBs 230 using the first two S-SSB slots 210 starting from a nominal S-SSB slot. In some examples, the UE 115-a may rely on a process of scheduling the UE 115-c to transmit S-SSB signals in the S-SSB slots 210 (e.g., gap slots) in the middle of the COT 215. However, if the UE 115-c is capable of transmitting the S-SSBs 230 in particular candidate S-SSB slots different from those indicated by the UE 115-a, the S-SSB transmission may be unsuccessful and the COT 215 may be lost.

Instead, the wireless communications system 200 may support SLSS UEs, including the UE 115-c, which may be capable of transmitting the S-SSBs 230 in any of the S-SSB slots 210 that may be gap slots. In such cases, the UE 115-a may receive a signal 225 from the UE 115-c indicative of a capability of the UE 115-c to transmit the S-SSBs 230 during the S-SSB slots 210. There may be multiple options for how the UE 115-a may receive indication of the capability of the UE 115-c. For example, the UE 115-a may learn the capability of the UE 115-c via an RRC message exchange. In such cases, the UE 115-a and the UE 115-c may establish an RRC connection (e.g., via the communication link 205). Before an RRC message exchange, the UE 115-a may be unable to schedule the UE 115-c to pad the S-SSB slots 210 with respective S-SSBs 230.

Alternatively, the UE 115-c may indicate its capability to the UE 115-a via an S-SSB. That is, the UE 115-a and the UE 115-c may refrain from establishing an RRC connection, and instead the UE 115-c may transmit an S-SSB to indicate a quantized transmission capability with limited code points. The S-SSB may include a limited quantity of master information bit (MIB) spare bits. For example, the S-SSB may indicate whether the UE 115-c is capable of transmitting S-SSBs in each of the S-SSB slots 210 or a subset of the S-SSB slots 210. If more code points are available, the UE 115-c may use the S-SSB to further indicate an exact subset of S-SSB slots 210 in which the UE 115-c may transmit S-SSBs 230.

Based on receiving the indication of the capability of the UE 115-c to transmit the S-SSB 230 in the gap slot (e.g., via an RRC message or an S-SSB), the UE 115-a may schedule the UE 115-c to transmit the S-SSB 230 in the gap slot and the UE 115-c may transmit the S-SSB 230 accordingly. In some examples, the UE 115-c may transmit the S-SSB 230 via a different communication link 205 than that used for transmitting the signal indicating the capability.

In some cases, after learning of the capability of the UE 115-c, the UE 115-a may identify one or more of the S-SSB slots 210 in which the UE 115-c may be unable to transmit S-SSBs. If the UE 115-c lacks a capability to transmit the S-SSBs in the S-SSB slots 210 creating the gap in the COT 215, the UE 115-a may perform some other procedure to facilitate transmission of the sidelink messages 220 during the COT 215 to the UE 115-c. For example, the UE 115-a may adjust its scheduling for the MCSt, which may include moving a starting position of the MCSt (the COT 215) to avoid the un-paddable S-SSB slots 210 in which the UE 115-c is unable to transmit the S-SSBs. That is, the UE 115-a may adjust a starting position of the multiple contiguous slots of the COT 215 to avoid a gap slot.

Alternatively, the UE 115-a may perform an additional LBT procedure or operation before continuing transmission of the sidelink message 220 after the gap slot (e.g., the one or more S-SSB slots 210 in which the UE 115-c is unable to transmit the padding S-SSBs). For example, the UE 115-a may terminate the COT 215 at an S-SSB slot 210 in which the UE 115-c is unable to transmit an S-SSB. The UE 115-c may then perform an additional type-1 LBT procedure (e.g., a first type of LBT procedure) if the UE 115-a refrains from sharing the COT 215 for the later part of the MCSt. That is, the UE 115-a may terminate the COT 215 based on the indication that the UE 115-c lacks the capability to transmit the S-SSB during the S-SSB slot 210, where one or more remaining slots of the MCSt may be excluded from the COT 215. Then, the UE 115-a may perform the type-1 LBT procedure to reinitiate the COT 215 after the S-SSB slot 210, where the LBT procedure is a type-1 LBT procedure based on the one or more remaining slots being excluded from the COT 215.

In some other aspects, the UE 115-a may perform a type-2 LBT procedure (e.g., a second type of LBT procedure) if the remaining slots of the MCSt are within a shared region of the COT 215. That is, the UE 115-a may terminate the COT 215 based on the indication that the UE 115-c lacks the capability to transmit the S-SSB during the S-SSB slot 210, where one or more remaining slots of the MCSt may be within the COT 215. Then, the UE 115-a may perform the type-2 LBT procedure to reinitiate the COT 215 after the S-SSB slot 210, where the LBT procedure is a type-2 LBT procedure based on the one or more remaining slots being within the COT 215. Based on adjusting the starting time of the MCSt or reinitiating the COT 215 based on an LBT procedure, the UE 115-a may transmit, to the UE 115-b, at least a portion of the one or more sidelink messages 220 during the COT 215 and after the gap slot.

In some examples, the UE 115-b and the UE 115-c may be a same device. For example, the UE 115-a may initiate sidelink communications with the UE 115-b, which may be an SLSS UE, and the UE 115-b may also effectively pad the gap slot to maintain the sidelink communications with the UE 115-b. In such cases, the described techniques may be facilitated between two UEs 115 instead of three.

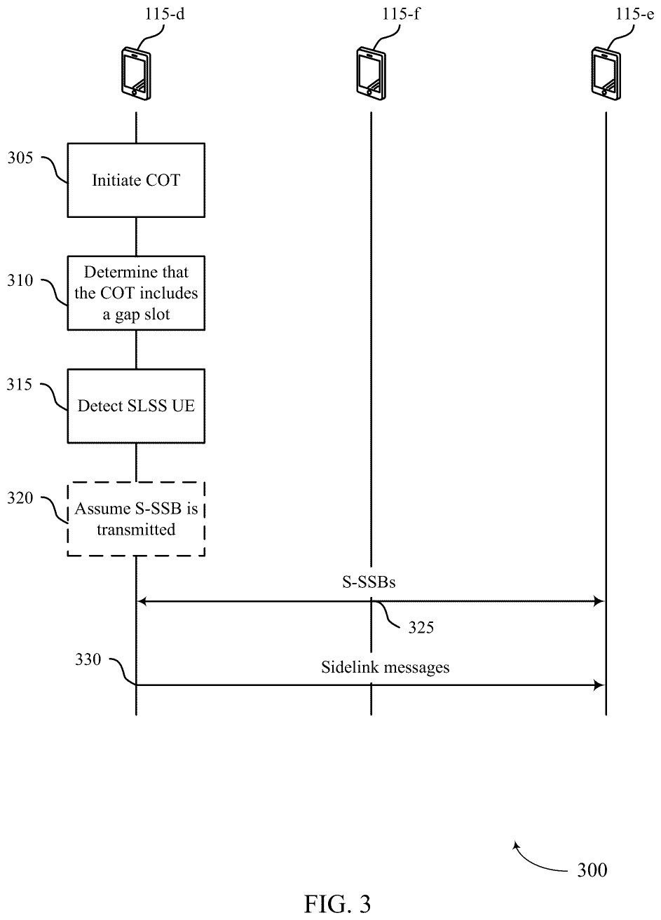

FIG. 3 shows an example of a process flow 300 that supports COT transmissions with a sidelink-synchronization signal block gap slot in accordance with one or more aspects of the present disclosure. The process flow 300 may implement aspects of wireless communications systems 100 and 200, or may be implemented by aspects of the wireless communications systems 100 and 200. For example, the process flow 300 may illustrate operations between a UE 115-d, a UE 115-e, and a UE 115-f which may be examples of corresponding devices described herein. The UE 115-d may be an example of a non-SLSS UE, the UE 115-f may be an example of an SLSS UE, and the UE 115-e may be an example of a non-SLSS UE or an SLSS UE. In the following description of the process flow 300, the operations between the UE 115-d, the UE 115-e, and the UE 115-f may be transmitted in a different order than the example order shown, or the operations performed by the UE 115-d, the UE 115-e, and the UE 115-f be performed in different orders or at different times. Some operations may also be omitted from the process flow 300, and other operations may be added to the process flow 300.

At 305, the UE 115-d may initiate a COT for transmission of one or more sidelink messages by the UE 115-d to the UE 115-e, where the COT includes multiple contiguous slots. That is, the COT may be configured for an MCSt of at least a portion of one or more sidelink messages by the UE 115-d, and the UE 115-d and the UE 115-e may communicate via sidelink communication.

At 310, the UE 115-d may determine that the multiple contiguous slots include a gap slot that is allocated for an S-SSB transmission, where the gap slot is unavailable for the transmission of the one or more sidelink messages by the UE 115-d. That is, the gap slot may be one or more S-SSB slots (e.g., S-SSB candidate slots) that may be excluded from a data resource pool, but configured for transmission of S-SSBs. The gap slot may occur in the middle of the MCSt and thus, interrupt the sidelink communications between the UE 115-d and the UE 115-e.

At 315, the UE 115-d may detect the UE 115-f, which may be capable of transmitting S-SSB transmissions. At 320, the UE 115-d may assume that an S-SSB is transmitted in the gap slot based on detection of the UE 115-f. That is, instead of detecting the UE 115-f and scheduling the UE 115-f to transmit an S-SSB during the gap slot, the UE 115-d may refrain from transmitting such signaling and instead just assume that the UE 115-f will transmit the S-SSB to pad the gap because it is an SLSS UE. At 325, UE 115-f may transmit S-SSBs during the gap slots.

At 330, the UE 115-d may transmit, to the UE 115-e, at least the portion of the one or more sidelink messages during the COT and after the gap slot, the transmission after the gap slot based on detection of the UE 115-f. That is, the UE 115-d may assume that the gap slot will be filled with an S-SSB and thus, may transmit the at least the portion of the one or more sidelink messages to the UE 115-e during the COT as if the UE 115-d had shared the COT with the UE 115-f.

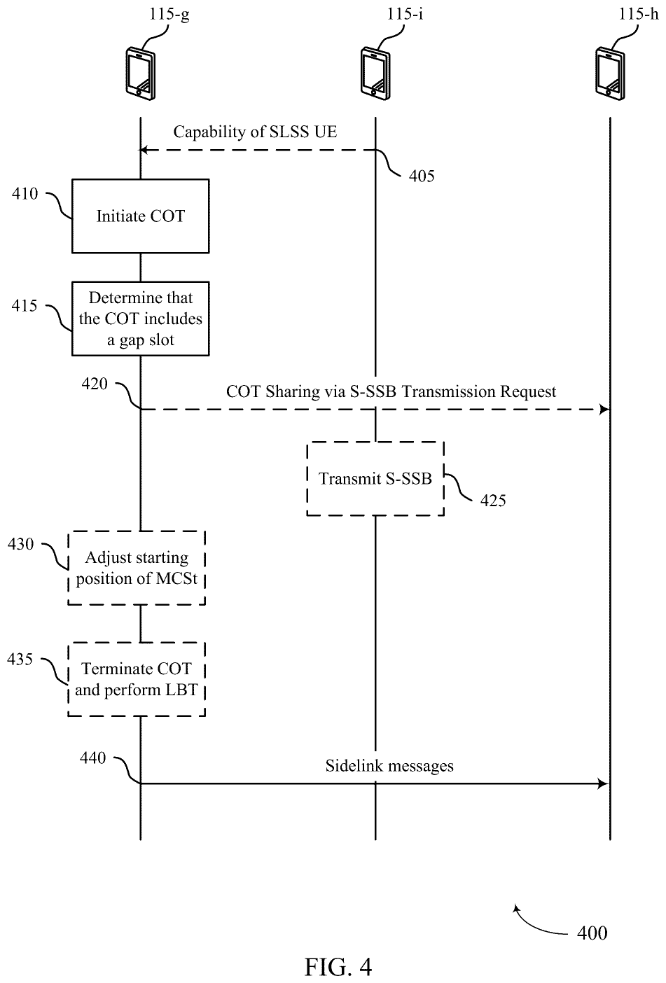

FIG. 4 shows an example of a process flow 400 that supports COT transmissions with a sidelink-synchronization signal block gap slot in accordance with one or more aspects of the present disclosure. The process flow 400 may implement aspects of wireless communications systems 100 and 200, or may be implemented by aspects of the wireless communications systems 100 and 200. For example, the process flow 400 may illustrate operations between a UE 115-g, a UE 115-h, and a UE 115-i which may be examples of corresponding devices described herein. The UE 115-g may be an example of a non-SLSS UE, the UE 115-i may be an example of an SLSS UE, and the UE 115-h may be an example of a non-SLSS UE or an SLSS UE In the following description of the process flow 400, the operations between the UE 115-g, the UE 115-h, and the UE 115-i may be transmitted in a different order than the example order shown, or the operations performed by the UE 115-g, the UE 115-h, and the UE 115-i may be performed in different orders or at different times. Some operations may also be omitted from the process flow 400, and other operations may be added to the process flow 400.

At 405, UE 115-i may inform UE 115-g of a capability of UE 115-i to transmit S-SSB during gap slots. The gap slots may be initially scheduled S-SSB slots, as defined by a legacy standard, or may include additionally scheduled S-SSB slots. For example, the UE 115-g may receive an RRC message or an S-SSB indicating the capability of the UE 115-i.

At 410, the UE 115-g may initiate a COT for transmission of one or more sidelink messages by the UE 115-g to the UE 115-h, where the COT includes multiple contiguous slots. That is, the COT may be configured for an MCSt of at least a portion of one or more sidelink messages by the UE 115-g, and the UE 115-g and the UE 115-h may communicate via sidelink communication.

At 415, the UE 115-g may determine that the multiple contiguous slots include a gap slot that is allocated for an S-SSB transmission, where the gap slot is unavailable for the transmission of the one or more sidelink messages by the UE 115-g. That is, the gap slot may be one or more S-SSB slots (e.g., S-SSB candidate slots) that may be excluded from a data resource pool, but configured for transmission of S-SSBs. The gap slot may occur in the middle of the MCSt and thus, interrupt the sidelink communications between the UE 115-g and the UE 115-h.

At 420, if the UE 115-i is indeed capable of transmitting the S-SSB during the gap slot (as indicated at 405), the UE 115-g may schedule the UE 115-i to transmit the S-SSB in the gap slot. Accordingly, at 425, the UE 115-i may transmit the S-SSB in the gap slot to effectively pad the gap slot such that the UE 115-g may transmit at least the portion of the one or more sidelink messages in the COT.

Alternatively, at 430, if the UE 115-i was not capable of transmitting S-SSB during the gap slots, the UE 115-g may adjust a starting position of the multiple contiguous slots to avoid the gap slot based on the signal indicating that the UE 115-i lacks the capability to transmit the S-SSB transmissions during the gap slot. That is, if the gap slot is not padded, the UE 115-g may avoid the gap slot by adjusting the multiple contiguous slots of the COT to begin after the gap slot.

Alternatively, at 435, the UE 115-g may terminate the COT based on the signal indicating that the UE 115-i lacks the capability to transmit the S-SSB transmissions during the gap slot. The UE 115-g may then perform an LBT procedure to reinitiate the COT after the gap slot based on the termination. If the one or more remaining slots of the multiple contiguous slots are excluded from the COT, the LBT procedure may be a type-1 LBT procedure. If the one or more remaining slots of the multiple contiguous slots are included within the COT, the LBT procedure may be a type-2 LBT procedure.

At 440, the UE 115-g may transmit, to the UE 115-h, at least the portion of the one or more sidelink messages during the COT after performance of the procedure. For example, the UE 115-g may transmit the sidelink messages during the COT and after the gap slot based on the UE 115-i being capable of transmitting the padding S-SSB or based on the UE 115-g adjusting the starting position of the multiple contiguous slots or reinitiating the COT based on performing an LBT procedure.

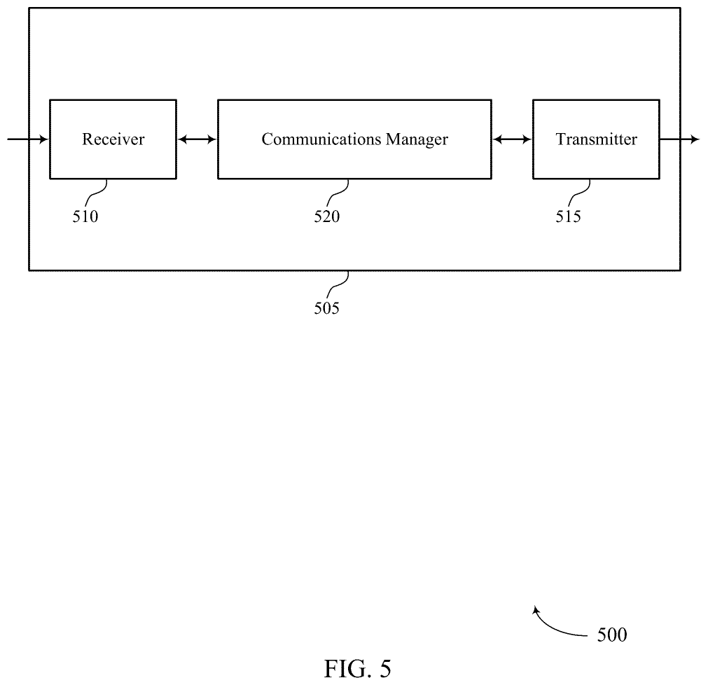

FIG. 5 shows a block diagram 500 of a device 505 that supports COT transmissions with a sidelink-synchronization signal block gap slot in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include one or more processors, one or more memories coupled with the one or more processors, and instructions stored in the one or more memories that are executable by the one or more processors to enable the one or more processors to perform the COT transmission features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to COT transmissions with a sidelink-synchronization signal block gap slot). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to COT transmissions with a sidelink-synchronization signal block gap slot). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of COT transmissions with a sidelink-synchronization signal block gap slot as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for initiating a COT for transmission of one or more sidelink messages by the first UE, where the COT includes multiple contiguous slots. The communications manager 520 is capable of, configured to, or operable to support a means for determining that the multiple contiguous slots include a gap slot that is allocated for a S-SSB transmission, where the gap slot is unavailable for the transmission of the one or more sidelink messages by the first UE. The communications manager 520 is capable of, configured to, or operable to support a means for detecting a second UE that is capable of transmitting S-SSB transmissions. The communications manager 520 is capable of, configured to, or operable to support a means for transmitting at least a portion of the one or more sidelink messages during the COT and after the gap slot, the transmission after the gap slot based on detection of the second UE.

Additionally, or alternatively, the communications manager 520 may support wireless communication in accordance with examples as disclosed herein. For example, the communications manager 520 is capable of, configured to, or operable to support a means for initiating a COT for transmission of one or more sidelink messages by the first UE, where the COT includes multiple contiguous slots. The communications manager 520 is capable of, configured to, or operable to support a means for determining that the multiple contiguous slots include a gap slot that is allocated for a S-SSB transmission, where the gap slot is unavailable for the transmission of the one or more sidelink messages by the first UE. The communications manager 520 is capable of, configured to, or operable to support a means for performing a procedure to facilitate the transmission of the one or more sidelink messages during the COT. The communications manager 520 is capable of, configured to, or operable to support a means for transmitting at least a portion of the one or more sidelink messages during the COT and after performance of the procedure.

Additionally, or alternatively, the communications manager 520 may support wireless communication in accordance with examples as disclosed herein. For example, the communications manager 520 is capable of, configured to, or operable to support a means for transmitting a signal indicative of a capability of the first UE to transmit S-SSB transmissions during a portion or all of a set of multiple S-SSB candidate slots. The communications manager 520 is capable of, configured to, or operable to support a means for transmitting one or more S-SSB transmissions during the set of multiple S-SSB candidate slots in accordance with the capability.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for COT transmissions with an S-SSB gap slot, which may reduce complexity, reduce latency, reduce power consumption, reduce signaling overhead, and improve communication quality.

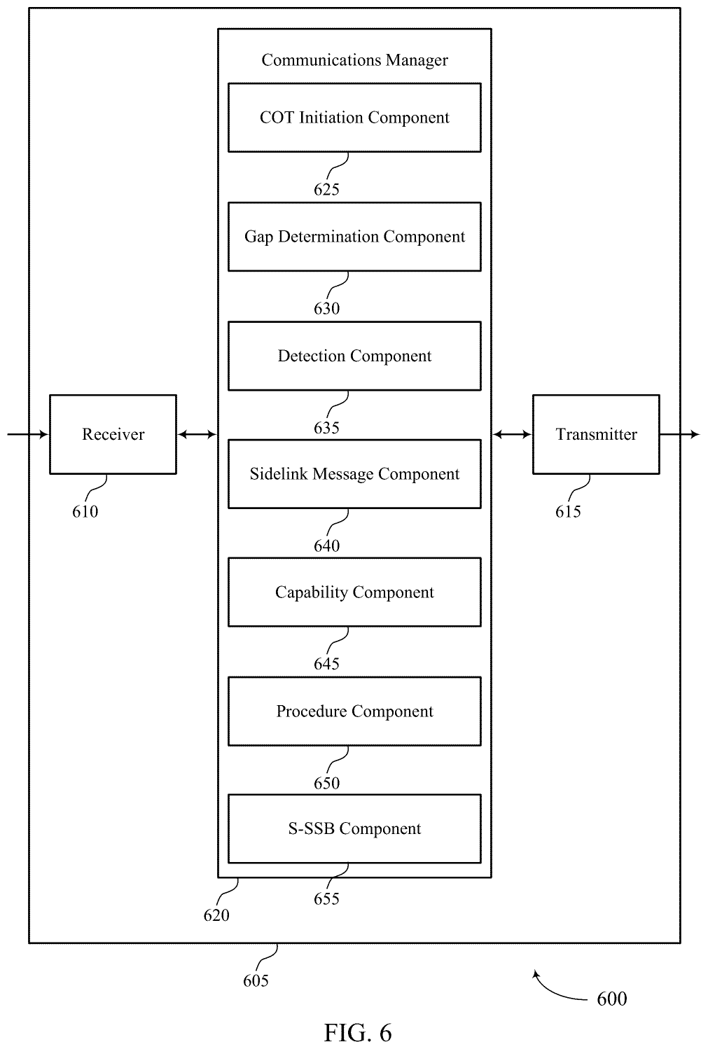

FIG. 6 shows a block diagram 600 of a device 605 that supports COT transmissions with a sidelink-synchronization signal block gap slot in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to COT transmissions with a sidelink-synchronization signal block gap slot). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to COT transmissions with a sidelink-synchronization signal block gap slot). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of COT transmissions with a sidelink-synchronization signal block gap slot as described herein. For example, the communications manager 620 may include a COT initiation component 625, a gap determination component 630, a detection component 635, a sidelink message component 640, a capability component 645, a procedure component 650, an S-SSB component 655, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The COT initiation component 625 is capable of, configured to, or operable to support a means for initiating a COT for transmission of one or more sidelink messages by the first UE, where the COT includes multiple contiguous slots. The gap determination component 630 is capable of, configured to, or operable to support a means for determining that the multiple contiguous slots include a gap slot that is allocated for a S-SSB transmission, where the gap slot is unavailable for the transmission of the one or more sidelink messages by the first UE. The detection component 635 is capable of, configured to, or operable to support a means for detecting a second UE that is capable of transmitting S-SSB transmissions. The sidelink message component 640 is capable of, configured to, or operable to support a means for transmitting at least a portion of the one or more sidelink messages during the COT and after the gap slot, the transmission after the gap slot based on detection of the second UE.

Additionally, or alternatively, the communications manager 620 may support wireless communication in accordance with examples as disclosed herein. The COT initiation component 625 is capable of, configured to, or operable to support a means for initiating a COT for transmission of one or more sidelink messages by the first UE, where the COT includes multiple contiguous slots. The gap determination component 630 is capable of, configured to, or operable to support a means for determining that the multiple contiguous slots include a gap slot that is allocated for a S-SSB transmission, where the gap slot is unavailable for the transmission of the one or more sidelink messages by the first UE. The procedure component 650 is capable of, configured to, or operable to support a means for performing a procedure to facilitate the transmission of the one or more sidelink messages during the COT. The sidelink message component 640 is capable of, configured to, or operable to support a means for transmitting at least a portion of the one or more sidelink messages during the COT and after performance of the procedure.

Additionally, or alternatively, the communications manager 620 may support wireless communication in accordance with examples as disclosed herein. The capability component 645 is capable of, configured to, or operable to support a means for transmitting a signal indicative of a capability of the first UE to transmit S-SSB transmissions during a portion or all of a set of multiple S-SSB candidate slots. The S-SSB component 655 is capable of, configured to, or operable to support a means for transmitting one or more S-SSB transmissions during the set of multiple S-SSB candidate slots in accordance with the capability.

In some cases, the COT initiation component 625, the gap determination component 630, the detection component 635, the sidelink message component 640, the capability component 645, the procedure component 650, and the S-SSB component 655 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the COT initiation component 625, the gap determination component 630, the detection component 635, the sidelink message component 640, the capability component 645, the procedure component 650, and the S-SSB component 655 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

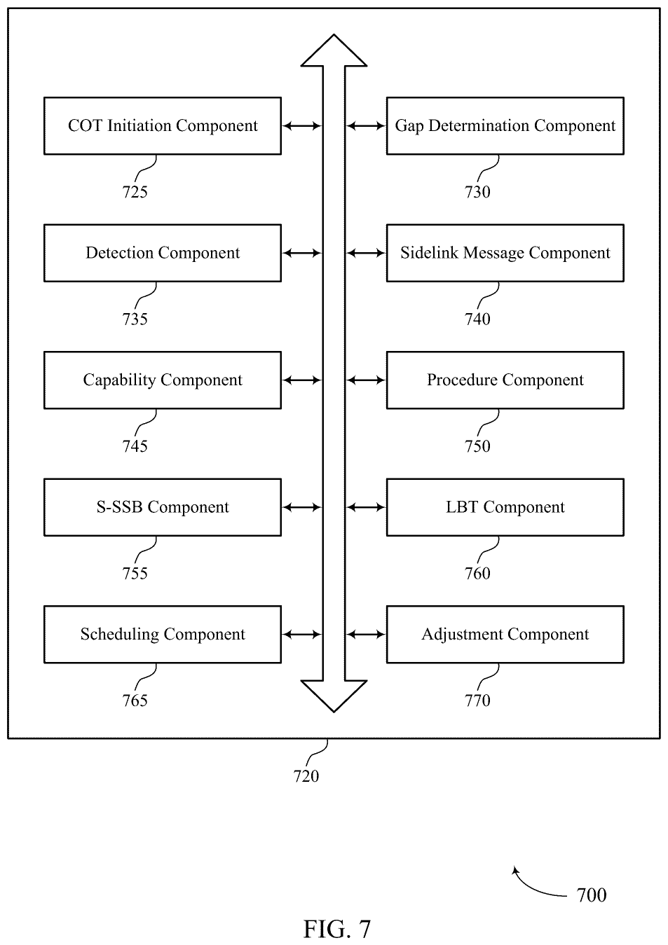

FIG. 7 shows a block diagram 700 of a communications manager 720 that supports COT transmissions with a sidelink-synchronization signal block gap slot in accordance with one or more aspects of the present disclosure. The communications manager 720 may be an example of aspects of a communications manager 520, a communications manager 620, or both, as described herein. The communications manager 720, or various components thereof, may be an example of means for performing various aspects of COT transmissions with a sidelink-synchronization signal block gap slot as described herein. For example, the communications manager 720 may include a COT initiation component 725, a gap determination component 730, a detection component 735, a sidelink message component 740, a capability component 745, a procedure component 750, an S-SSB component 755, an LBT component 760, a scheduling component 765, an adjustment component 770, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The COT initiation component 725 is capable of, configured to, or operable to support a means for initiating a COT for transmission of one or more sidelink messages by the first UE, where the COT includes multiple contiguous slots. The gap determination component 730 is capable of, configured to, or operable to support a means for determining that the multiple contiguous slots include a gap slot that is allocated for a S-SSB transmission, where the gap slot is unavailable for the transmission of the one or more sidelink messages by the first UE. The detection component 735 is capable of, configured to, or operable to support a means for detecting a second UE that is capable of transmitting S-SSB transmissions. The sidelink message component 740 is capable of, configured to, or operable to support a means for transmitting at least a portion of the one or more sidelink messages during the COT and after the gap slot, the transmission after the gap slot based on detection of the second UE.

In some examples, the detection component 735 is capable of, configured to, or operable to support a means for assuming that a S-SSB is transmitted in the gap slot based on the detection of the second UE. In some examples, the gap slot is configured for transmission by the second UE of the S-SSB transmission.

In some examples, the LBT component 760 is capable of, configured to, or operable to support a means for refraining from performing a listen-before-talk procedure during the COT after the gap slot based on the detection of the second UE.

In some examples, the first UE lacks a capability to transmit sidelink synchronization signals and. In some examples, the second UE is capable of transmitting sidelink synchronization signals.

Additionally, or alternatively, the communications manager 720 may support wireless communication in accordance with examples as disclosed herein. In some examples, the COT initiation component 725 is capable of, configured to, or operable to support a means for initiating a COT for transmission of one or more sidelink messages by the first UE, where the COT includes multiple contiguous slots. In some examples, the gap determination component 730 is capable of, configured to, or operable to support a means for determining that the multiple contiguous slots include a gap slot that is allocated for a S-SSB transmission, where the gap slot is unavailable for the transmission of the one or more sidelink messages by the first UE.. The procedure component 750 is capable of, configured to, or operable to support a means for performing a procedure to facilitate the transmission of the one or more sidelink messages during the COT. In some examples, the sidelink message component 740 is capable of, configured to, or operable to support a means for transmitting at least a portion of the one or more sidelink messages during the COT and after performance of the procedure.

In some examples, the capability component 745 is capable of, configured to, or operable to support a means for receiving a signal indicative of a capability of a second UE to transmit sidelink synchronization signal block transmissions during the gap slot, where the procedure to facilitate the transmission of the one or more sidelink messages during the COT is performed based on the capability.

In some examples, to support performing the procedure, the scheduling component 765 is capable of, configured to, or operable to support a means for scheduling the second UE to transmit the S-SSB transmissions during the gap slot based on a capability of the second UE.

In some examples, to support receiving the signal, the capability component 745 is capable of, configured to, or operable to support a means for establishing an RRC connection with the second UE. In some examples, to support receiving the signal, the capability component 745 is capable of, configured to, or operable to support a means for receiving an RRC message indicative of a capability of the second UE to transmit the S-SSB transmissions during the gap slot.

In some examples, to support receiving the signal, the capability component 745 is capable of, configured to, or operable to support a means for receiving a S-SSB indicative of a capability of the second UE to transmit the S-SSB transmissions during the gap slot, where the capability is quantized with one or more code points included in the S-SSB.

In some examples, the S-SSB is indicative of the capability of the second UE to transmit the S-SSB transmissions during all of a set of candidate slots that include the gap slot or during a subset of the set of candidate slots. In some examples, the subset includes the gap slot.

In some examples, to support performing the procedure, the adjustment component 770 is capable of, configured to, or operable to support a means for adjusting a starting position of the multiple contiguous slots to avoid the gap slot based on the signal indicating that the second UE lacks the capability to transmit the S-SSB transmissions during the gap slot.

In some examples, to support performing the procedure, the LBT component 760 is capable of, configured to, or operable to support a means for terminating the COT based on the signal indicating that the second UE lacks a capability to transmit the S-SSB transmissions during the gap slot, where one or more remaining slots of the multiple contiguous slots are excluded from the COT. In some examples, to support performing the procedure, the LBT component 760 is capable of, configured to, or operable to support a means for performing a listen-before-talk procedure to reinitiate the COT after the gap slot based on the termination, where the listen-before-talk procedure is of a first type based on the one or more remaining slots being excluded from the COT.

In some examples, terminating the COT based on the signal indicating that the second UE lacks a capability to transmit the S-SSB transmissions during the gap slot, where one or more remaining slots of the multiple contiguous slots are within the COT. In some examples, performing a listen-before-talk procedure to reinitiate the COT after the gap slot based on the termination, where the listen-before-talk procedure is of a second type based on the one or more remaining slots being within the COT.

Additionally, or alternatively, the communications manager 720 may support wireless communication in accordance with examples as disclosed herein. In some examples, the capability component 745 is capable of, configured to, or operable to support a means for transmitting a signal indicative of a capability of the first UE to transmit S-SSB transmissions during a portion or all of a set of multiple S-SSB candidate slots. The S-SSB component 755 is capable of, configured to, or operable to support a means for transmitting one or more S-SSB transmissions during the set of multiple S-SSB candidate slots in accordance with the capability.

In some examples, the scheduling component 765 is capable of, configured to, or operable to support a means for receiving a message that schedules the first UE to transmit a S-SSB transmission during one of the S-SSB candidate slots in accordance with the capability. In some examples, the S-SSB component 755 is capable of, configured to, or operable to support a means for transmitting the S-SSB transmission during the portion or all of the set of multiple S-SSB candidate slots based on the message.

In some examples, to support transmitting the signal, the capability component 745 is capable of, configured to, or operable to support a means for establishing an RRC connection with a second UE. In some examples, to support transmitting the signal, the capability component 745 is capable of, configured to, or operable to support a means for transmitting an RRC message indicative of the capability of the first UE to transmit the S-SSB transmission during the portion or all of the set of multiple S-SSB candidate slots.

In some examples, to support transmitting the signal, the capability component 745 is capable of, configured to, or operable to support a means for transmitting a S-SSB indicative of the capability of the first UE to transmit the S-SSB transmission during the portion or all of the set of multiple S-SSB candidate slots, where the capability is quantized with one or more code points included in the S-SSB transmission.

In some cases, the COT initiation component 725, the gap determination component 730, the detection component 735, the sidelink message component 740, the capability component 745, the procedure component 750, the S-SSB component 755, the LBT component 760, the scheduling component 765, and the adjustment component 770 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the COT initiation component 725, the gap determination component 730, the detection component 735, the sidelink message component 740, the capability component 745, the procedure component 750, the S-SSB component 755, the LBT component 760, the scheduling component 765, and the adjustment component 770.

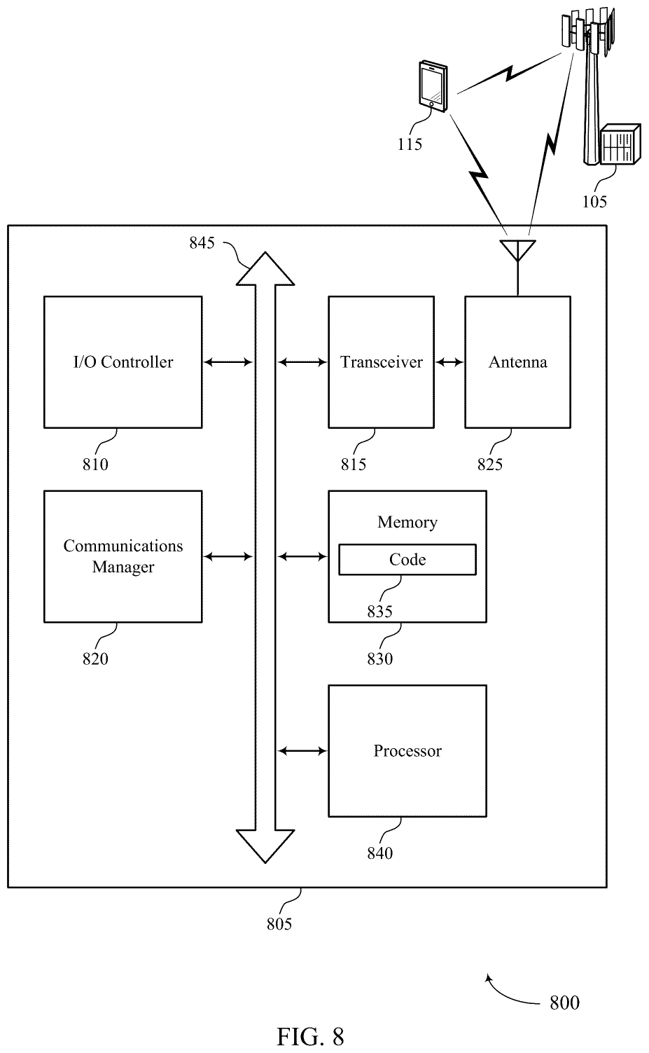

FIG. 8 shows a diagram of a system 800 including a device 805 that supports COT transmissions with a sidelink-synchronization signal block gap slot in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting COT transmissions with a sidelink-synchronization signal block gap slot). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for initiating a COT for transmission of one or more sidelink messages by the first UE, where the COT includes multiple contiguous slots. The communications manager 820 is capable of, configured to, or operable to support a means for determining that the multiple contiguous slots include a gap slot that is allocated for a S-SSB transmission, where the gap slot is unavailable for the transmission of the one or more sidelink messages by the first UE. The communications manager 820 is capable of, configured to, or operable to support a means for detecting a second UE that is capable of transmitting S-SSB transmissions. The communications manager 820 is capable of, configured to, or operable to support a means for transmitting at least a portion of the one or more sidelink messages during the COT and after the gap slot, the transmission after the gap slot based on detection of the second UE.

Additionally, or alternatively, the communications manager 820 may support wireless communication in accordance with examples as disclosed herein. For example, the communications manager 820 is capable of, configured to, or operable to support a means for initiating a COT for transmission of one or more sidelink messages by the first UE, where the COT includes multiple contiguous slots. The communications manager 820 is capable of, configured to, or operable to support a means for determining that the multiple contiguous slots include a gap slot that is allocated for a S-SSB transmission, where the gap slot is unavailable for the transmission of the one or more sidelink messages by the first UE. The communications manager 820 is capable of, configured to, or operable to support a means for performing a procedure to facilitate the transmission of the one or more sidelink messages during the COT. The communications manager 820 is capable of, configured to, or operable to support a means for transmitting at least a portion of the one or more sidelink messages during the COT and after performance of the procedure.

Additionally, or alternatively, the communications manager 820 may support wireless communication in accordance with examples as disclosed herein. For example, the communications manager 820 is capable of, configured to, or operable to support a means for transmitting a signal indicative of a capability of the first UE to transmit S-SSB transmissions during a portion or all of a set of multiple S-SSB candidate slots. The communications manager 820 is capable of, configured to, or operable to support a means for transmitting one or more S-SSB transmissions during the set of multiple S-SSB candidate slots in accordance with the capability.

By including or configuring the communications manager 820 in accordance with examples as described herein, the device 805 may support techniques for COT transmissions with an S-SSB gap slot, which may reduce complexity, reduce latency, reduce power consumption, reduce signaling overhead, and improve communication quality.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of COT transmissions with a sidelink-synchronization signal block gap slot as described herein, or the at least one processor 840 and the at least one memory 830 may be otherwise configured to, individually or collectively, perform or support such operations.

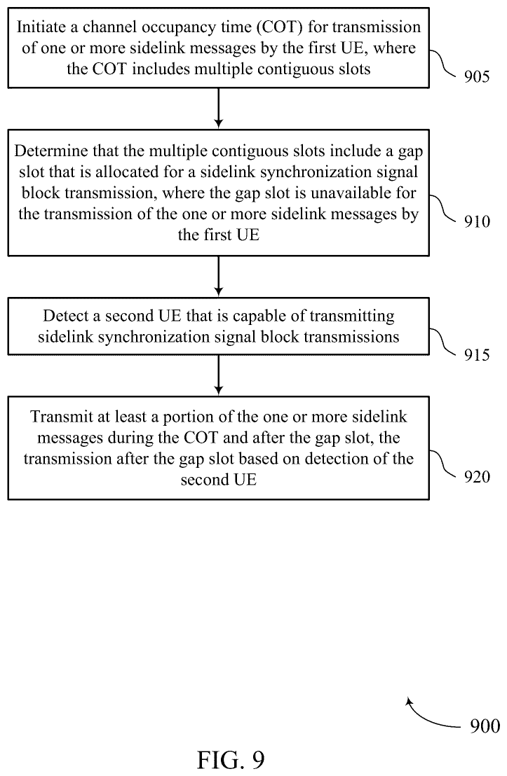

FIG. 9 shows a flowchart illustrating a method 900 that supports COT transmissions with a sidelink-synchronization signal block gap slot in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include initiating a COT for transmission of one or more sidelink messages by the first UE, where the COT includes multiple contiguous slots. The operations of 905 may be performed in accordance with examples as disclosed herein. In some examples, aspects of the operations of 905 may be performed by a COT initiation component 725 as described with reference to FIG. 7.

At 910, the method may include determining that the multiple contiguous slots include a gap slot that is allocated for a S-SSB transmission, where the gap slot is unavailable for the transmission of the one or more sidelink messages by the first UE. The operations of 910 may be performed in accordance with examples as disclosed herein. In some examples, aspects of the operations of 910 may be performed by a gap determination component 730 as described with reference to FIG. 7.

At 915, the method may include detecting a second UE that is capable of transmitting S-SSB transmissions. The operations of 915 may be performed in accordance with examples as disclosed herein. In some examples, aspects of the operations of 915 may be performed by a detection component 735 as described with reference to FIG. 7.

At 920, the method may include transmitting at least a portion of the one or more sidelink messages during the COT and after the gap slot, the transmission after the gap slot based on detection of the second UE. The operations of 920 may be performed in accordance with examples as disclosed herein. In some examples, aspects of the operations of 920 may be performed by a sidelink message component 740 as described with reference to FIG. 7.

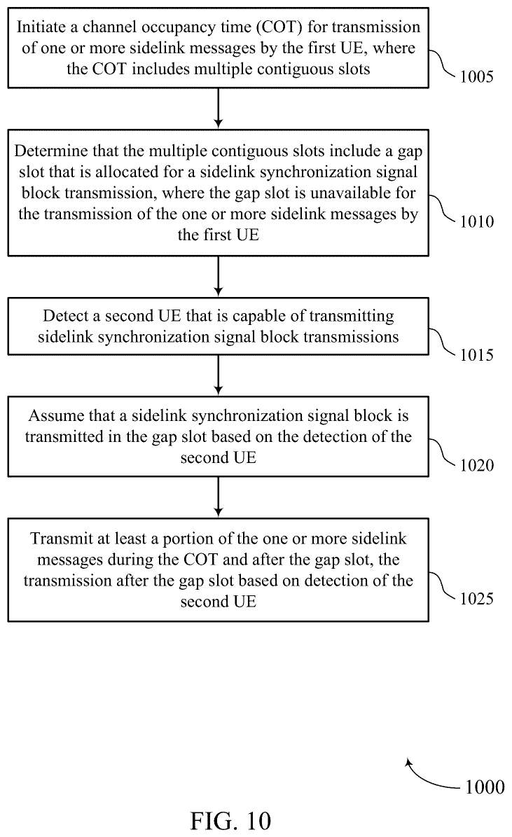

FIG. 10 shows a flowchart illustrating a method 1000 that supports COT transmissions with a sidelink-synchronization signal block gap slot in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include initiating a COT for transmission of one or more sidelink messages by the first UE, where the COT includes multiple contiguous slots. The operations of 1005 may be performed in accordance with examples as disclosed herein. In some examples, aspects of the operations of 1005 may be performed by a COT initiation component 725 as described with reference to FIG. 7.

At 1010, the method may include determining that the multiple contiguous slots include a gap slot that is allocated for a S-SSB transmission, where the gap slot is unavailable for the transmission of the one or more sidelink messages by the first UE. The operations of 1010 may be performed in accordance with examples as disclosed herein. In some examples, aspects of the operations of 1010 may be performed by a gap determination component 730 as described with reference to FIG. 7.

At 1015, the method may include detecting a second UE that is capable of transmitting S-SSB transmissions. The operations of 1015 may be performed in accordance with examples as disclosed herein. In some examples, aspects of the operations of 1015 may be performed by a detection component 735 as described with reference to FIG. 7.

At 1020, the method may include assuming that a S-SSB is transmitted in the gap slot based on the detection of the second UE. The operations of 1020 may be performed in accordance with examples as disclosed herein. In some examples, aspects of the operations of 1020 may be performed by a detection component 735 as described with reference to FIG. 7.

At 1025, the method may include transmitting at least a portion of the one or more sidelink messages during the COT and after the gap slot, the transmission after the gap slot based on detection of the second UE. The operations of 1025 may be performed in accordance with examples as disclosed herein. In some examples, aspects of the operations of 1025 may be performed by a sidelink message component 740 as described with reference to FIG. 7.

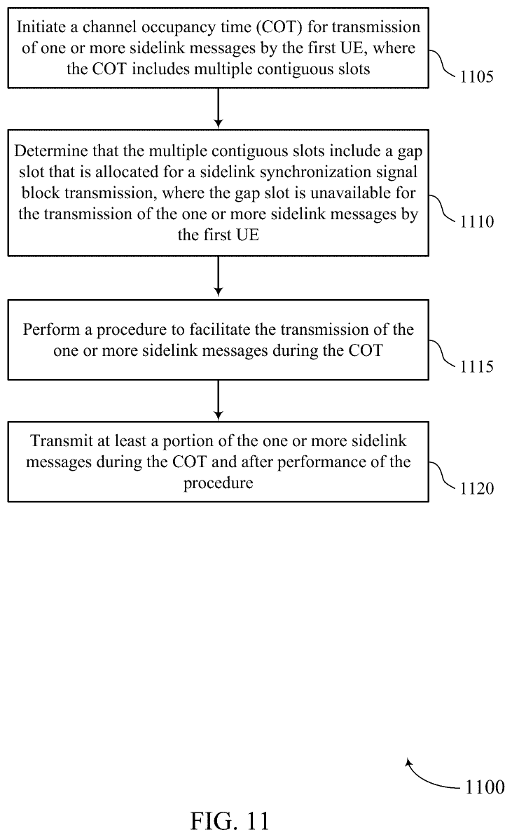

FIG. 11 shows a flowchart illustrating a method 1100 that supports COT transmissions with a sidelink-synchronization signal block gap slot in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include initiating a COT for transmission of one or more sidelink messages by the first UE, where the COT includes multiple contiguous slots. The operations of 1105 may be performed in accordance with examples as disclosed herein. In some examples, aspects of the operations of 1105 may be performed by a COT initiation component 725 as described with reference to FIG. 7.

At 1110, the method may include determining that the multiple contiguous slots include a gap slot that is allocated for a S-SSB transmission, where the gap slot is unavailable for the transmission of the one or more sidelink messages by the first UE. The operations of 1110 may be performed in accordance with examples as disclosed herein. In some examples, aspects of the operations of 1110 may be performed by a gap determination component 730 as described with reference to FIG. 7.

At 1115, the method may include performing a procedure to facilitate the transmission of the one or more sidelink messages during the COT. The operations of 1115 may be performed in accordance with examples as disclosed herein. In some examples, aspects of the operations of 1115 may be performed by a procedure component 750 as described with reference to FIG. 7.

At 1120, the method may include transmitting at least a portion of the one or more sidelink messages during the COT and after performance of the procedure. The operations of 1120 may be performed in accordance with examples as disclosed herein. In some examples, aspects of the operations of 1120 may be performed by a sidelink message component 740 as described with reference to FIG. 7.

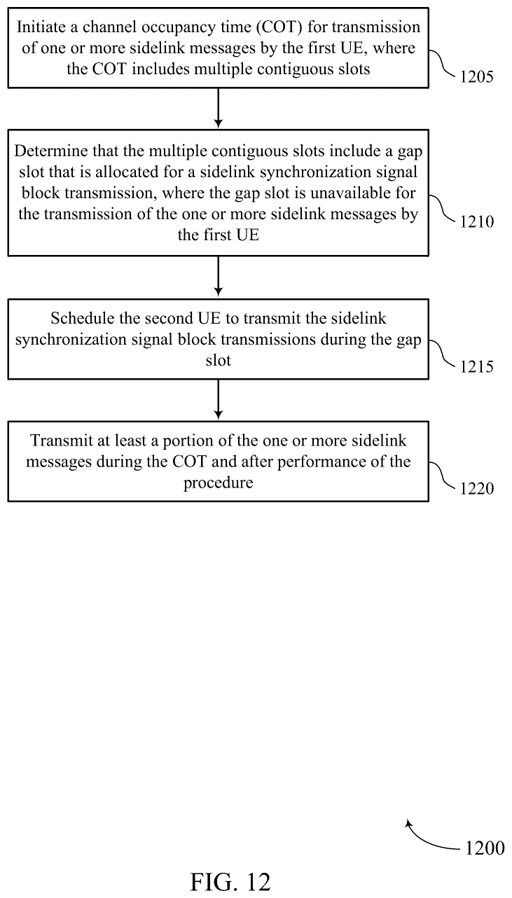

FIG. 12 shows a flowchart illustrating a method 1200 that supports COT transmissions with a sidelink-synchronization signal block gap slot in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include initiating a COT for transmission of one or more sidelink messages by the first UE, where the COT includes multiple contiguous slots. The operations of 1205 may be performed in accordance with examples as disclosed herein. In some examples, aspects of the operations of 1205 may be performed by a COT initiation component 725 as described with reference to FIG. 7.

At 1210, the method may include determining that the multiple contiguous slots include a gap slot that is allocated for a S-SSB transmission, where the gap slot is unavailable for the transmission of the one or more sidelink messages by the first UE. The operations of 1210 may be performed in accordance with examples as disclosed herein. In some examples, aspects of the operations of 1210 may be performed by a gap determination component 730 as described with reference to FIG. 7.

At 1215, the method may include scheduling the second UE to transmit the S-SSB transmissions during the gap slot. The operations of 1215 may be performed in accordance with examples as disclosed herein. In some examples, aspects of the operations of 1215 may be performed by a scheduling component 765 as described with reference to FIG. 7.

At 1220, the method may include transmitting at least a portion of the one or more sidelink messages during the COT and after performance of the procedure. The operations of 1220 may be performed in accordance with examples as disclosed herein. In some examples, aspects of the operations of 1220 may be performed by a sidelink message component 740 as described with reference to FIG. 7.

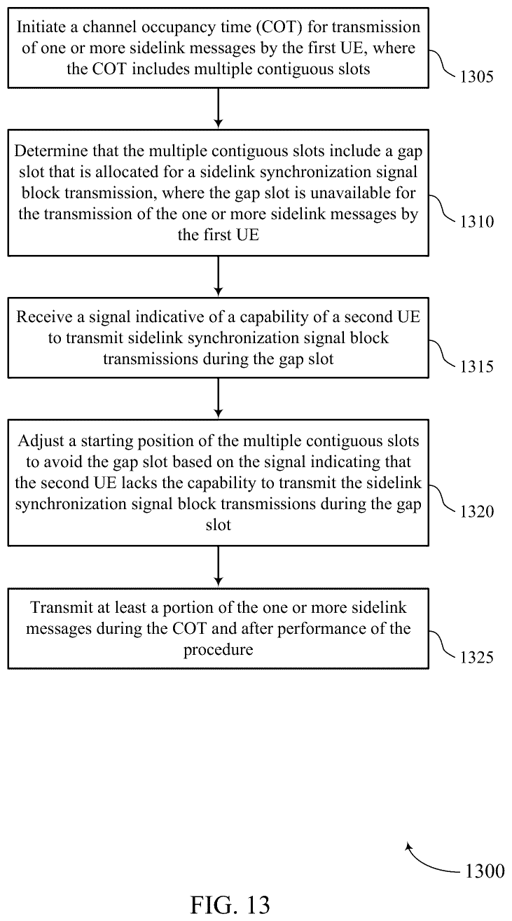

FIG. 13 shows a flowchart illustrating a method 1300 that supports COT transmissions with a sidelink-synchronization signal block gap slot in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include initiating a COT for transmission of one or more sidelink messages by the first UE, where the COT includes multiple contiguous slots. The operations of 1305 may be performed in accordance with examples as disclosed herein. In some examples, aspects of the operations of 1305 may be performed by a COT initiation component 725 as described with reference to FIG. 7.

At 1310, the method may include determining that the multiple contiguous slots include a gap slot that is allocated for a S-SSB transmission, where the gap slot is unavailable for the transmission of the one or more sidelink messages by the first UE. The operations of 1310 may be performed in accordance with examples as disclosed herein. In some examples, aspects of the operations of 1310 may be performed by a gap determination component 730 as described with reference to FIG. 7.

At 1315, the method may include receiving a signal indicative of a capability of a second UE to transmit S-SSB transmissions during the gap slot. The operations of 1315 may be performed in accordance with examples as disclosed herein. In some examples, aspects of the operations of 1315 may be performed by a capability component 745 as described with reference to FIG. 7.

At 1320, the method may include adjusting a starting position of the multiple contiguous slots to avoid the gap slot based on the signal indicating that the second UE lacks the capability to transmit the S-SSB transmissions during the gap slot. The operations of 1320 may be performed in accordance with examples as disclosed herein. In some examples, aspects of the operations of 1320 may be performed by an adjustment component 770 as described with reference to FIG. 7.

At 1325, the method may include transmitting at least a portion of the one or more sidelink messages during the COT and after performance of the procedure. The operations of 1325 may be performed in accordance with examples as disclosed herein. In some examples, aspects of the operations of 1325 may be performed by a sidelink message component 740 as described with reference to FIG. 7.

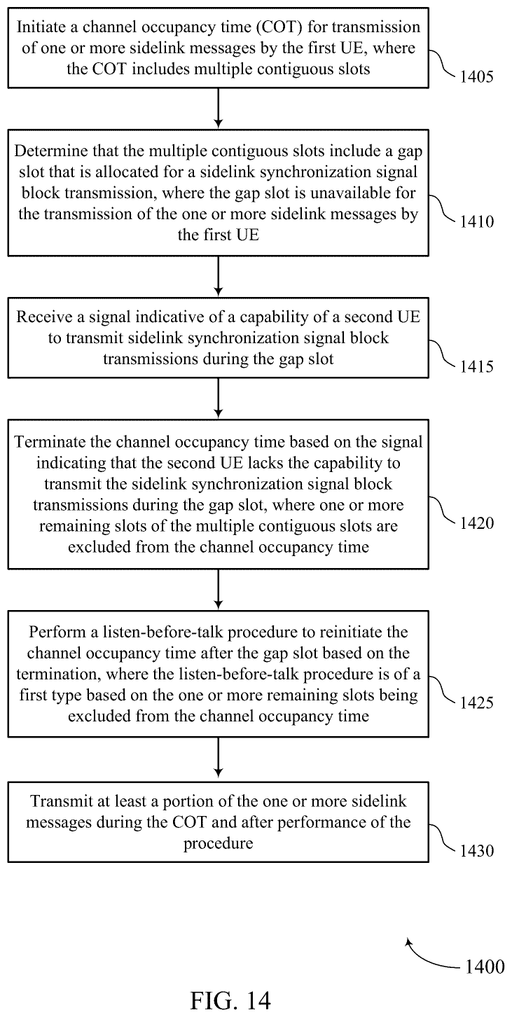

FIG. 14 shows a flowchart illustrating a method 1400 that supports COT transmissions with a sidelink-synchronization signal block gap slot in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include initiating a COT for transmission of one or more sidelink messages by the first UE, where the COT includes multiple contiguous slots. The operations of 1405 may be performed in accordance with examples as disclosed herein. In some examples, aspects of the operations of 1405 may be performed by a COT initiation component 725 as described with reference to FIG. 7.

At 1410, the method may include determining that the multiple contiguous slots include a gap slot that is allocated for a S-SSB transmission, where the gap slot is unavailable for the transmission of the one or more sidelink messages by the first UE. The operations of 1410 may be performed in accordance with examples as disclosed herein. In some examples, aspects of the operations of 1410 may be performed by a gap determination component 730 as described with reference to FIG. 7.

At 1415, the method may include receiving a signal indicative of a capability of a second UE to transmit S-SSB transmissions during the gap slot. The operations of 1415 may be performed in accordance with examples as disclosed herein. In some examples, aspects of the operations of 1415 may be performed by a capability component 745 as described with reference to FIG. 7.

At 1420, the method may include terminating the COT based on the signal indicating that the second UE lacks the capability to transmit the S-SSB transmissions during the gap slot, where one or more remaining slots of the multiple contiguous slots are excluded from the COT. The operations of 1420 may be performed in accordance with examples as disclosed herein. In some examples, aspects of the operations of 1420 may be performed by an LBT component 760 as described with reference to FIG. 7.

At 1425, the method may include performing a listen-before-talk procedure to reinitiate the COT after the gap slot based on the termination, where the listen-before-talk procedure is of a first type based on the one or more remaining slots being excluded from the COT. The operations of 1425 may be performed in accordance with examples as disclosed herein. In some examples, aspects of the operations of 1425 may be performed by an LBT component 760 as described with reference to FIG. 7.

At 1430, the method may include transmitting at least a portion of the one or more sidelink messages during the COT and after performance of the procedure. The operations of 1430 may be performed in accordance with examples as disclosed herein. In some examples, aspects of the operations of 1430 may be performed by a sidelink message component 740 as described with reference to FIG. 7.

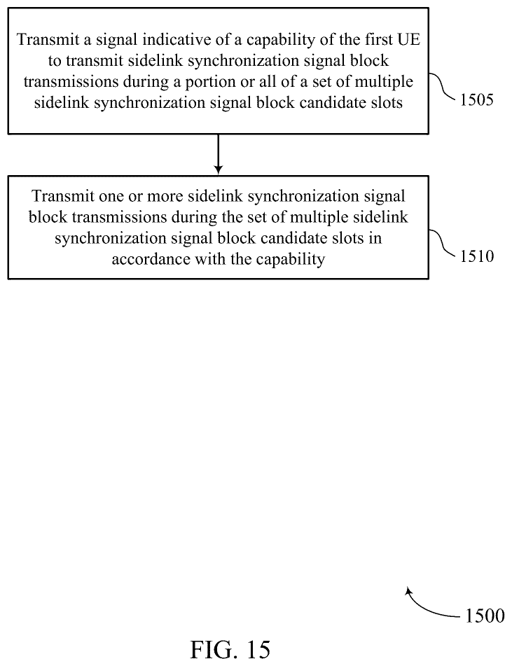

FIG. 15 shows a flowchart illustrating a method 1500 that supports COT transmissions with a sidelink-synchronization signal block gap slot in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting a signal indicative of a capability of the first UE to transmit S-SSB transmissions during a portion or all of a set of multiple S-SSB candidate slots. The operations of 1505 may be performed in accordance with examples as disclosed herein. In some examples, aspects of the operations of 1505 may be performed by a capability component 745 as described with reference to FIG. 7.

At 1510, the method may include transmitting one or more S-SSB transmissions during the set of multiple S-SSB candidate slots in accordance with the capability. The operations of 1510 may be performed in accordance with examples as disclosed herein. In some examples, aspects of the operations of 1510 may be performed by an S-SSB component 755 as described with reference to FIG. 7.

The following provides an overview of aspects of the present disclosure:

Aspect 1: A method for wireless communication at a first UE, comprising: initiating a COT for transmission of one or more sidelink messages by the first UE, wherein the COT includes multiple contiguous slots; determining that the multiple contiguous slots include a gap slot that is allocated for a S-SSB transmission, wherein the gap slot is unavailable for the transmission of the one or more sidelink messages by the first UE; detecting a second UE that is capable of transmitting S-SSB transmissions; and transmitting at least a portion of the one or more sidelink messages during the COT and after the gap slot, the transmission after the gap slot based at least in part on detection of the second UE.

Aspect 2: The method of aspect 1, further comprising: assuming that a S-SSB is transmitted in the gap slot based at least in part on the detection of the second UE.

Aspect 3: The method of any of aspects 1 through 2, wherein the gap slot is configured for transmission by the second UE of the S-SSB transmission.

Aspect 4: The method of any of aspects 1 through 3, further comprising: refraining from performing a LBT procedure during the COT after the gap slot based at least in part on the detection of the second UE.

Aspect 5: The method of any of aspects 1 through 4, wherein the first UE lacks a capability to transmit sidelink synchronization signals and the second UE is capable of transmitting sidelink synchronization signals.

Aspect 6: A method for wireless communication at a first UE, comprising: initiating a COT for transmission of one or more sidelink messages by the first UE, wherein the COT includes multiple contiguous slots; determining that the multiple contiguous slots include a gap slot that is allocated for a S-SSB transmission, wherein the gap slot is unavailable for the transmission of the one or more sidelink messages by the first UE; performing a procedure to facilitate the transmission of the one or more sidelink messages during the COT; and transmitting at least a portion of the one or more sidelink messages during the COT and after performance of the procedure.

Aspect 7: The method of aspect 6, further comprising: receiving a signal indicative of a capability of a second UE to transmit sidelink synchronization signal block transmissions during the gap slot, wherein the procedure to facilitate the transmission of the one or more sidelink messages during the COT is performed based at least in part on the capability.

Aspect 8: The method of any of aspects 6 through 9, wherein performing the procedure comprises: adjusting a starting position of the multiple contiguous slots to avoid the gap slot based at least in part on the signal indicating that the second UE lacks the capability to transmit the S-SSB transmissions during the gap slot.

Aspect 9: The method of any of aspects 6 through 8, wherein performing the procedure comprises: terminating the COT based at least in part on the signal indicating that the second UE lacks the capability to transmit the S-SSB transmissions during the gap slot, wherein one or more remaining slots of the multiple contiguous slots are excluded from the COT; and performing a LBT procedure to reinitiate the COT after the gap slot based at least in part on the termination, wherein the LBT procedure is of a first type based at least in part on the one or more remaining slots being excluded from the COT.

Aspect 10: The method of any of aspects 6 through 9, wherein performing the procedure comprise terminating the COT based at least in part on the signal indicating that the second UE lacks the capability to transmit the S-SSB transmissions during the gap slot, wherein one or more remaining slots of the multiple contiguous slots are within the COT; and performing a LBT procedure to reinitiate the COT after the gap slot based at least in part on the termination, wherein the LBT procedure is of a second type based at least in part on the one or more remaining slots being within the COT.

Aspect 11: The method of aspect 6 through 10, wherein performing the procedure comprises: scheduling the second UE to transmit the S-SSB transmissions during the gap slot based at least in part on the capability of the second UE.

Aspect 12: The method of any of aspects 6 through 11, wherein receiving the signal comprises: establishing a RRC connection with the second UE; and receiving a RRC message indicative of the capability of the second UE to transmit the S-SSB transmissions during the gap slot.

Aspect 13: The method of any of aspects 6 through 12, wherein receiving the signal comprises: receiving a S-SSB indicative of the capability of the second UE to transmit the S-SSB transmissions during the gap slot, wherein the capability is quantized with one or more code points included in the S-SSB.

Aspect 14: The method of aspect 13, wherein the S-SSB is indicative of the capability of the second UE to transmit the S-SSB transmissions during all of a set of candidate slots that include the gap slot or during a subset of the set of candidate slots, the subset includes the gap slot.

Aspect 15: A method for wireless communication at a first UE, comprising: transmitting a signal indicative of a capability of the first UE to transmit S-SSB transmissions during a portion or all of a plurality of S-SSB candidate slots; and transmitting one or more S-SSB transmissions during the plurality of S-SSB candidate slots in accordance with the capability.

Aspect 16: The method of aspect 15, further comprising: receiving a message that schedules the first UE to transmit a S-SSB transmission during one of the S-SSB candidate slots in accordance with the capability; and transmitting the S-SSB transmission during the portion or all of the plurality of S-SSB candidate slots based at least in part on the message.

Aspect 17: The method of any of aspects 15 through 16, wherein transmitting the signal comprises: establishing a RRC connection with a second UE; and transmitting a RRC message indicative of the capability of the first UE to transmit the S-SSB transmission during the portion or all of the plurality of S-SSB candidate slots.

Aspect 18: The method of any of aspects 15 through 17, wherein transmitting the signal comprises: transmitting a S-SSB indicative of the capability of the first UE to transmit the S-SSB transmission during the portion or all of the plurality of S-SSB candidate slots, wherein the capability is quantized with one or more code points included in the S-SSB transmission.

Aspect 19: A first UE for wireless communication, comprising one or more memories storing processor-executable code, and one or more processors coupled with the one or more memories and individually or collectively configured to cause the first UE to perform a method of any of aspects 1 through 6.

Aspect 20: A first UE for wireless communication, comprising at least one means for performing a method of any of aspects 1 through 6.

Aspect 21: A non-transitory computer-readable medium storing code for wireless communication, the code comprising instructions executable by a processor to perform a method of any of aspects 1 through 6.

Aspect 22: A first UE for wireless communication, comprising one or more memories storing processor-executable code, and one or more processors coupled with the one or more memories and individually or collectively configured to cause the first UE to perform a method of any of aspects 7 through 14.

Aspect 23: A first UE for wireless communication, comprising at least one means for performing a method of any of aspects 7 through 14.

Aspect 24: A non-transitory computer-readable medium storing code for wireless communication, the code comprising instructions executable by a processor to perform a method of any of aspects 7 through 14.

Aspect 25: A first UE for wireless communication, comprising one or more memories storing processor-executable code, and one or more processors coupled with the one or more memories and individually or collectively configured to cause the first UE to perform a method of any of aspects 15 through 18.

Aspect 26: A first UE for wireless communication, comprising at least one means for performing a method of any of aspects 15 through 18.

Aspect 27: A non-transitory computer-readable medium storing code for wireless communication, the code comprising instructions executable by a processor to perform a method of any of aspects 15 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories, wherein the one or more processors are individually or collectively configured to cause the UE to:
initiate a channel occupancy time (COT) for transmission of one or more sidelink messages by the first UE, wherein the COT includes multiple contiguous slots;
determine that the multiple contiguous slots include a gap slot that is allocated for a sidelink synchronization signal block transmission, wherein the gap slot is unavailable for the transmission of the one or more sidelink messages by the first UE;
detect a second UE that is capable of transmitting sidelink synchronization signal block transmissions; and
transmit at least a portion of the one or more sidelink messages during the COT and after the gap slot, the transmission after the gap slot based at least in part on detection of the second UE.

2. The first UE of claim 1, wherein the one or more processors are individually or collectively further configured to cause the first UE to:
assume that a sidelink synchronization signal block is transmitted in the gap slot based at least in part on the detection of the second UE.

3. The first UE of claim 1, wherein the gap slot is configured for transmission by the second UE of the sidelink synchronization signal block transmission.

4. The first UE of claim 1, wherein the one or more processors are individually or collectively configured to cause the first UE to:
refrain from performing a listen-before-talk procedure during the COT after the gap slot based at least in part on the detection of the second UE.

5. The first UE of claim 1, wherein the first UE lacks a capability to transmit sidelink synchronization signals and the second UE is capable of transmitting sidelink synchronization signals.

6. A first user equipment (UE), comprising:
one or more memories storing processor-executable code; and
one or more processors coupled with the one or more memories and individually or collectively operable to execute the code to cause the first UE to:
initiate a channel occupancy time (COT) for transmission of one or more sidelink messages by the first UE, wherein the COT includes multiple contiguous slots;
determine that the multiple contiguous slots include a gap slot that is allocated for a sidelink synchronization signal block transmission, wherein the gap slot is unavailable for the transmission of the one or more sidelink messages by the first UE;
perform a procedure to facilitate the transmission of the one or more sidelink messages during the COT; and
transmit at least a portion of the one or more sidelink messages during the COT and after performance of the procedure.

7. The first UE of claim 6, wherein the one or more processors are individually or collectively configured to cause the first UE to perform the procedure by being individually or collectively configured to cause the first UE to:
receive a signal indicative of a capability of a second UE to transmit sidelink synchronization signal block transmissions during the gap slot, wherein the procedure to facilitate the transmission of the one or more sidelink messages during the COT is performed based at least in part on the capability.

8. The first UE of claim 6, wherein the one or more processors are individually or collectively configured to cause the first UE to perform the procedure by being individually or collectively configured to cause the first UE to:
adjust a starting position of the multiple contiguous slots to avoid the gap slot based at least in part on the signal indicating that a second UE lacks a capability to transmit the sidelink synchronization signal block transmissions during the gap slot.

9. The first UE of claim 6, wherein the one or more processors are individually or collectively configured to cause the first UE to perform the procedure by being individually or collectively configured to cause the first UE to:
terminate the channel occupancy time based at least in part on the signal indicating that a second UE lacks a capability to transmit the sidelink synchronization signal block transmissions during the gap slot, wherein one or more remaining slots of the multiple contiguous slots are excluded from the channel occupancy time; and
perform a listen-before-talk procedure to reinitiate the channel occupancy time after the gap slot based at least in part on the termination, wherein the listen-before-talk procedure is of a first type based at least in part on the one or more remaining slots being excluded from the channel occupancy time.

10. The first UE of claim 6, wherein the one or more processors are individually or collectively configured to cause the first UE to perform the procedure by being individually or collectively configured to cause the first UE to:
terminate the channel occupancy time based at least in part on the signal indicating that a second UE lacks a capability to transmit the sidelink synchronization signal block transmissions during the gap slot, wherein one or more remaining slots of the multiple contiguous slots are within the channel occupancy time; and
perform a listen-before-talk procedure to reinitiate the channel occupancy time after the gap slot based at least in part on the termination, wherein the listen-before-talk procedure is of a second type based at least in part on the one or more remaining slots being within the channel occupancy time.

11. The first UE of claim 6, wherein the one or more processors are individually or collectively configured to cause the first UE to perform the procedure by being individually or collectively configured to cause the first UE to:
schedule a second UE to transmit the sidelink synchronization signal block transmissions during the gap slot based at least in part on a capability of the second UE.

12. The first UE of claim 6, wherein the one or more processors are individually or collectively configured to cause the first UE to receive the signal by being individually or collectively configured to cause the first UE to:
establish a radio resource control connection with a second UE; and
receive a radio resource control message indicative of a capability of the second UE to transmit the sidelink synchronization signal block transmissions during the gap slot.

13. The first UE of claim 6, wherein the one or more processors are individually or collectively configured to cause the first UE to receive the signal by being individually or collectively configured to cause the first UE to:
receive a sidelink synchronization signal block indicative of a capability of a second UE to transmit the sidelink synchronization signal block transmissions during the gap slot, wherein the capability is quantized with one or more code points included in the sidelink synchronization signal block.

14. The first UE of claim 13, wherein the sidelink synchronization signal block is indicative of a capability of a second UE to transmit the sidelink synchronization signal block transmissions during all of a set of candidate slots that include the gap slot or during a subset of the set of candidate slots, wherein the subset includes the gap slot.

15. A first user equipment (UE), comprising:
one or more memories storing processor-executable code; and
one or more processors coupled with the one or more memories and individually or collectively operable to execute the code to cause the first UE to:
transmit a signal indicative of a capability of the first UE to transmit sidelink synchronization signal block transmissions during a portion or all of a plurality of sidelink synchronization signal block candidate slots; and
transmit one or more sidelink synchronization signal block transmissions during the plurality of sidelink synchronization signal block candidate slots in accordance with the capability.

16. The first UE of claim 15, wherein the one or more processors are individually or collectively further configured to cause the first UE to:
receive a message that schedules the first UE to transmit a sidelink synchronization signal block transmission during one of the sidelink synchronization signal block candidate slots in accordance with the capability; and
transmit the sidelink synchronization signal block transmission during the portion or all of the plurality of sidelink synchronization signal block candidate slots based at least in part on the message.

17. The first UE of claim 15, wherein the one or more processors are individually or collectively configured to cause the first UE to transmit the signal by being individually or collectively configured to cause the first UE to:
establish a radio resource control connection with a second UE; and
transmit a radio resource control message indicative of the capability of the first UE to transmit the sidelink synchronization signal block transmission during the portion or all of the plurality of sidelink synchronization signal block candidate slots.

18. The first UE of claim 15, wherein the one or more processors are individually or collectively configured to cause the first UE to transmit the signal by being individually or collectively configured to cause the first UE to:
transmit a sidelink synchronization signal block indicative of the capability of the first UE to transmit the sidelink synchronization signal block transmission during the portion or all of the plurality of sidelink synchronization signal block candidate slots, wherein the capability is quantized with one or more code points included in the sidelink synchronization signal block transmission.

19. A method for wireless communication at a first user equipment (UE), comprising:
initiating a channel occupancy time (COT) for transmission of one or more sidelink messages by the first UE, wherein the COT includes multiple contiguous slots;
determining that the multiple contiguous slots include a gap slot that is allocated for a sidelink synchronization signal block transmission, wherein the gap slot is unavailable for the transmission of the one or more sidelink messages by the first UE;
performing a procedure to facilitate the transmission of the one or more sidelink messages during the COT; and
transmitting at least a portion of the one or more sidelink messages during the COT and after performance of the procedure.

20. The method of claim 19, further comprising:
receiving a signal indicative of a capability of a second UE to transmit sidelink synchronization signal block transmissions during the gap slot, wherein the procedure to facilitate the transmission of the one or more sidelink messages during the COT is performed based at least in part on the capability.

21. The method of claim 19, wherein performing the procedure comprises:
adjusting a starting position of the multiple contiguous slots to avoid the gap slot based at least in part on the signal indicating that a second UE lacks a capability to transmit the sidelink synchronization signal block transmissions during the gap slot.

22. The method of claim 19, wherein performing the procedure comprises:
terminating the channel occupancy time based at least in part on the signal indicating that a second UE lacks a capability to transmit the sidelink synchronization signal block transmissions during the gap slot, wherein one or more remaining slots of the multiple contiguous slots are excluded from the channel occupancy time; and
performing a listen-before-talk procedure to reinitiate the channel occupancy time after the gap slot based at least in part on the termination, wherein the listen-before-talk procedure is of a first type based at least in part on the one or more remaining slots being excluded from the channel occupancy time.

23. The method of claim 19, wherein performing the procedure comprises:
terminating the channel occupancy time based at least in part on the signal indicating that a second UE lacks a capability to transmit the sidelink synchronization signal block transmissions during the gap slot, wherein one or more remaining slots of the multiple contiguous slots are within the channel occupancy time; and
performing a listen-before-talk procedure to reinitiate the channel occupancy time after the gap slot based at least in part on the termination, wherein the listen-before-talk procedure is of a second type based at least in part on the one or more remaining slots being within the channel occupancy time.

24. The method of claim 19, wherein performing the procedure comprises:
scheduling a second UE to transmit the sidelink synchronization signal block transmissions during the gap slot based at least in part on a capability of the second UE.

25. The method of claim 19, wherein receiving the signal comprises:
establishing a radio resource control connection with a second UE; and
receiving a radio resource control message indicative of a capability of the second UE to transmit the sidelink synchronization signal block transmissions during the gap slot.

26. The method of claim 19, wherein receiving the signal comprises:
receiving a sidelink synchronization signal block indicative of a capability of a second UE to transmit the sidelink synchronization signal block transmissions during the gap slot, wherein the capability is quantized with one or more code points included in the sidelink synchronization signal block.

27. The method of claim 26, wherein the sidelink synchronization signal block is indicative of the capability of a second UE to transmit the sidelink synchronization signal block transmissions during all of a set of candidate slots that include the gap slot or during a subset of the set of candidate slots, wherein the subset includes the gap slot.
